(19) United States
(12) Patent Application Publication
(10) Pub. No.: US 2004/0064886 A1
(43) Pub. Date: Apr. 8, 2004

(54) Patient transport apparatus

(76) Inventors: Curtis L. Alverson, Shelbyville, IN (US); Mark E. Haufler, Cincinnati, OH (US); John W. Koenig, Cincinnati, OH (US); Barry P. Markwick, Columbus, OH (US); Michael T. Kopczewski, Grove City, OH (US); Steven L. Paletti, Worthington, OH (US); George K. Chow, Columbus, OH (US); Peter A. Koloski, Columbus, OH (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/600,780

(22) Filed: Jun. 20, 2003

Related U.S. Application Data
(60) Provisional application No. 60/390,539, filed on Jun. 21, 2002.

(51) Int. Cl. A61G 7/10

(52) U.S. Cl. 5/83.1

(57) ABSTRACT

The present invention includes a patient transport apparatus adapted to support a patient in a plurality of positions including a standing position and a seated position.

### BACKGROUND AND SUMMARY OF THE INVENTION

This application claims the benefit of U.S. Provisional Patent Application No. 60/390,539, which is expressly incorporated by reference.

The present invention relates to a patient transport apparatus. More particularly, the present invention relates to a walker and transport apparatus comprising a frame adaptable to support a patient in a standing position and a seated position.

The prior art includes many types of walkers, wheelchairs, and similar devices for supporting and aiding the mobility of disabled or elderly persons or patients, and others. See, for example, U.S. Pat. Nos. 6,125,957 to Kauffmann, 5,702,326 to Renteria, 5,058,912 to Harroun, 2,792,052 to Johannesen, RE 24817 to Hogan, as well as PCT applications WO 98/33466 and WO 00/67819, the latter of which is assigned to Hill-Rom Services, Inc., also the assignee of this application. In addition, see U.S. application Ser. Nos. 09/849,580 and 60/310,092. All the documents cited herein are specifically incorporated by reference.

In accordance with the present invention, a patient transport apparatus is provided. In one embodiment, the patient transport apparatus of the present invention includes a frame adapted to support a patient in a plurality of positions including a standing position and a seated position, a plurality of wheels coupled to the frame, a seat coupled to the frame above the plurality of wheels, the seat being movable from a generally vertical storage position to a generally horizontal seat position, and a braking mechanism coupled to the seat, the braking mechanism being activatable to brake at least one of the plurality of wheels when the seat is moved from the generally vertical storage position to the generally horizontal seat position.

In one illustrated embodiment, the seat is adapted to assume the horizontal seat position when the patient is using the apparatus as a chair and adapted to assume a vertical storage position adjacent to the frame when the patient is in a standing position using the apparatus as a walker.

In another embodiment, a patient transport apparatus is provided, which includes a base, a frame extending upward from the base, the frame being configured to support a patient, first and second spaced apart arm members coupled to the frame, the first and second arm members having an arm member length, first and second space apart leg members cantilevered from the base, the first and second leg members having a leg member length, the first and second leg members having an arcuate shape extending outwardly from the base such that the leg member length is greater than the arm member length.

Further, in alternative embodiments, the leg members are shaped to fit substantially underneath a patient bed, and adapted to engage a foot section of the bed when the foot end is moved from a position substantially parallel to the floor surface to a position substantially perpendicular to the floor surface.

In an additional embodiment, the first leg member is coupled to a left side of the vertical frame adjacent to a bottom end of the frame. Further, in an embodiment, the first leg member has a rear portion extending substantially parallel to the frame, a middle portion extending substantially perpendicular to the vertical frame, and a front portion extending substantially parallel to the vertical frame, with the rear portion being coupled to the vertical frame, and the middle portion being substantially longer than either the rear portion or the front portion of the leg member.

In another embodiment of the present invention, a patient transport apparatus is provided, including a frame adaptable for movably supporting a patient in a plurality of positions including a standing position and a seated position, and first and second spaced apart arm members coupled to the frame, the first and second arm members being vertically movable relative to the frame from a first position to be operable as hand supports when the patient is in the standing position and a second position located below the first position to be operable as arm supports when the patient is in the seated position, the first and second arm members also being pivotably coupled to the frame between an outwardly-extending use position and a downwardly pivoted storage position.

In one embodiment, a coupling mechanism is also provided, which couples the arm member to the frame. The coupling mechanism includes a pivot coupler adapted to permit rotation of the arm member from a first position aligned substantially parallel to the frame to a second position aligned substantially perpendicular to the frame, and a vertical adjustment coupler adapted to permit movement of the arm member from a third position adjacent the top portion of the frame to a fourth position adjacent to the middle portion of the frame.

In another embodiment of the present invention, a patient transport apparatus is provided, including a frame adaptable for movably supporting a patient in a plurality of positions including a standing position and a seated position, and a support surface coupled to the frame, the support surface being movable between a storage position and a use position. In one embodiment, the support surface is coupled to a top end of the frame. Further, in one embodiment, a support surface coupled to the top end of the frame, the support surface being pivotable between a storage position in which the support surface is aligned substantially parallel to a longitudinal axis of the frame and a use position in which the support surface is aligned substantially perpendicular to the longitudinal axis of the frame to support items thereon.

Additional features and advantages of the present invention will become apparent to those skilled in the art upon consideration of the drawings of the illustrated embodiments and accompanying description.

### BRIEF DESCRIPTION OF THE DRAWINGS

The detailed description particularly refers to the accompanying figures, in which:

FIG. 1 is a perspective view of a patient side of a patient transport apparatus in accordance with the present invention, with a seat in a downwardly pivoted use position;

FIG. 2 is a perspective view of a caregiver side of the apparatus of FIG. 1;

FIG. 3 is a perspective view of the patient side of the apparatus of FIG. 1, with the seat in an upwardly pivoted storage position;

FIG. 4 is a cross-sectional view of a portion of a frame of the apparatus of FIG. 1, showing portions of a brake mechanism when the seat is in the storage position of FIG. 3;

FIG. 5 is a cross-sectional view of the frame of the apparatus of FIG. 1, showing portions of the brake mechanism, which is actuated when the seat is moved into the use position of FIG. 1;

FIG. 6 is a side elevational view of the apparatus of FIG. 1;

FIG. 7 is a side elevational view of the apparatus of FIG. 1 positioned at the foot of a bed, showing a caregiver using a support surface of the apparatus and a patient lying in the bed;

FIGS. 8a and 8b are cross-sectional views of two embodiments of a coupling mechanism for an arm member, showing mechanisms for rotating the arm member about a horizontal axis, and for adjusting a vertical height of the arm member with respect to the frame;

FIG. 9 is a side elevational view of the arm member, with a portion cut away to show a brake release mechanism;

FIG. 10 is a partial perspective view of the top end of the frame of another embodiment of the present invention, showing a patient seated in the apparatus, a caregiver standing behind the apparatus grasping the handles of the apparatus, and a support surface in a storage position;

FIG. 11 is a perspective view of the embodiment of FIG. 10, adjacent a bed, showing the bed and the patient therein in a seated position, and the support surface extended over the lap of the patient;

FIG. 12 is a perspective view of the embodiment of FIG. 10, showing the bed and the patient therein in a seated position, and the support surface extended in front of the patient; and

FIG. 13 is a perspective view of the top end of the frame of another embodiment of the present invention, showing a support surface having two hinged portions and a person demonstrating how the support surface can be extended;

FIG. 14 is a perspective view of another embodiment of the apparatus, showing in particular an alternate configuration of the frame, arm members, brake mechanism, handle, and foot supports;

FIG. 15 is a perspective view of another embodiment of the apparatus, showing in particular an on-board computing device, storage of an oxygen tank, and elliptical-shaped arm members;

FIG. 16 is a perspective view of the patient side of another embodiment of the apparatus, showing in particular a movable top portion of the frame;

FIG. 17 is a perspective view of the caregiver side of another embodiment of the apparatus, showing in particular a configuration of a storage receptacle, brake release mechanism, and leg members;

FIG. 18 is a perspective view of the caregiver side of the apparatus showing in particular an alternate configuration of a storage receptacle; and

FIG. 19 is a perspective view of the caregiver side of another embodiment of the apparatus showing in particular an alternate configuration of storage receptacles and leg members.

### DETAILED DESCRIPTION OF THE DRAWINGS

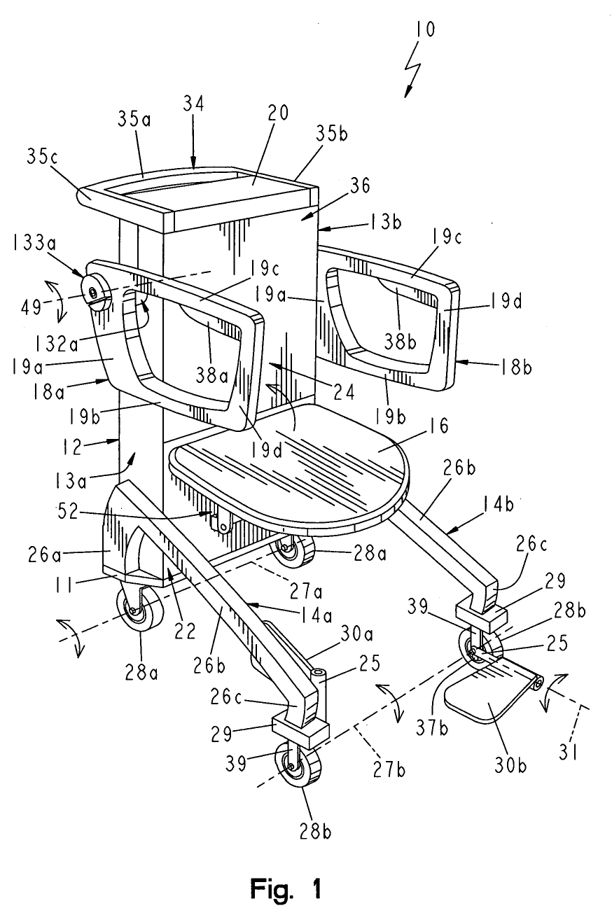

An exemplary embodiment of the present invention is shown in FIG. 1. As shown in FIG. 1, patient transport apparatus 10 comprises a base 11, a vertical frame 12 extending upwardly from base 11, and first and second leg members 14a, 14b extending outwardly from base 11. The illustrated embodiment also includes first and second arm members 18a, 18b coupled to frame 12 by spacers 132a, 132b (132b not shown) and arm coupling mechanisms 133a, 133b, respectively (133b not shown), a seat 16 coupled to frame 12, a pair of rear wheels 28a, a pair of front wheels 28b, a support surface 20, a handle 34, and foot rests 30a, 30b. In the illustrated embodiment, base 11, vertical frame 12, leg members 14a, 14b, first and second arm members 18a, 18b, seat 16, support surface 20, and handle 34 are molded using a foam core material well known in the art. It is understood, however, that these components may be made from any plastic, metal, wood, composite, or other suitable material.

In general, base 11 functions as a support for frame 12, leg members 14a, 14b, and rear wheels 28a. Vertical frame 12 has a first side 13a, a second side 13b, a top end 36, a bottom end 22, and a middle portion 24. In the embodiment of FIG. 1, vertical frame 12 is of a generally rectangular shape; however, it is understood that vertical frame 12 may assume any other suitable shape. Alternatively or in addition, vertical frame 12 is of substantially continuous or one-piece construction, or is made up of multiple sections; for example, one or more of top end 36, bottom end 22, and middle portion 24 may be separately fabricated and coupled together by an adhesive, mechanical coupler, or other suitable coupling mechanism.

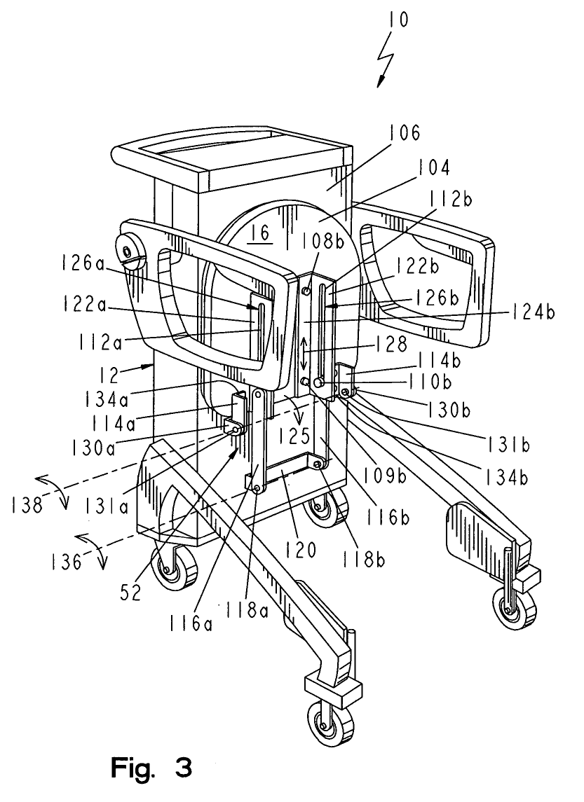

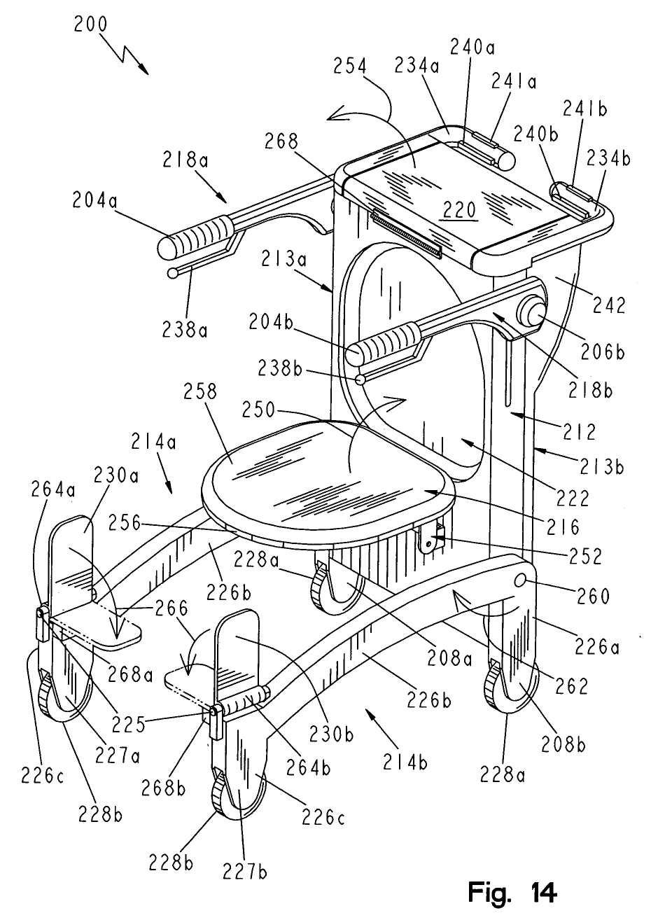

Vertical frame 12 is coupled to base 11 at bottom end 22. Optionally, middle portion 24 of vertical frame 12 includes a slight curve, recess, or concavity shaped to receive seat 16 in the vertical or storage position of FIG. 3, i.e., so that seat 16 is substantially flush with frame 12 in the vertical position, and/or to provide a more comfortable back rest for a patient seated on seat 16. See, for example, FIG. 14.

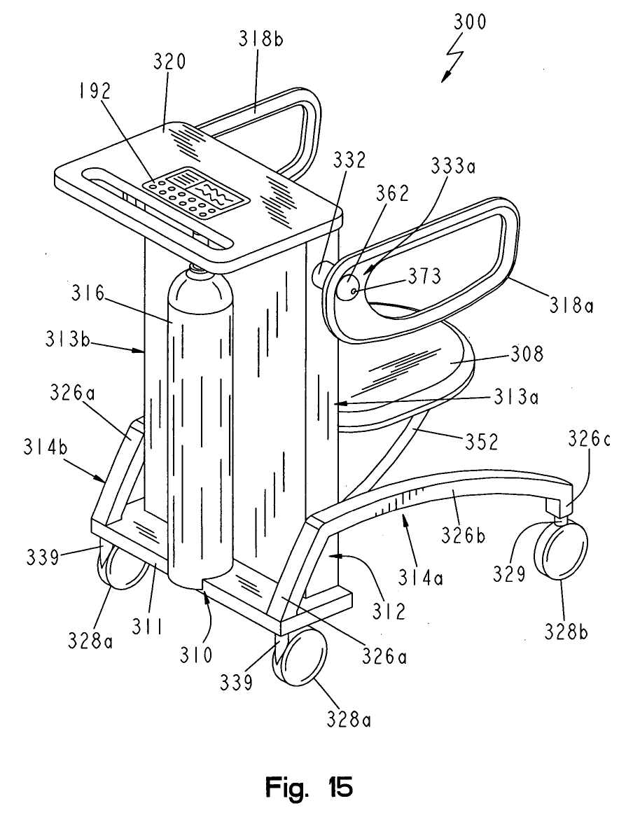

Leg members 14a, 14b support vertical frame 12 and are substantially identically shaped. As shown, for example, in FIGS. 1 and 15, rear portions 26a of leg members 14a, 14b, are coupled to base 11, 311. Referring to FIG. 1, leg members 14a, 14b are spaced apart in that first leg member 14a is coupled to a first side of base 11 adjacent the first side 13a of vertical frame 12, and second leg member 14b is coupled to a second side of base 11 adjacent the second side 13b of vertical frame 12. Alternatively or in addition, leg members 14a, 14b are coupled to bottom end 22 of vertical frame 12. See, for example, FIG. 14. As shown in the figures, leg members 14a, 14b are generally parallel to one another. However, it is understood that leg members 14a, 14b may be arranged so that the distance between rear portions 26a is larger or smaller than the distance between middle portions 26b and/or front portions 26c, as may be appropriate or desirable in a particular embodiment.

In the illustrated embodiments, leg members 14a, 14b have a generally curved, rounded, or arcuate shape in which rear portions 26a curve upward from base 11 along sides 13a, 13b of vertical frame sides 12, middle portions 26b are cantilevered from base 11 or otherwise extend forwardly or outwardly from frame sides 13a, 13b, and front portions 26c bend, curve or otherwise extend downwardly toward front wheels 28b. Optionally, a horizontal plate 29 is positioned between front portion 26c and front wheel 28b as shown in FIG. 1.

Also in the illustrated embodiments, the middle portion 26b of leg members 14a, 14b is longer in length than either rear portion 26a or front portion 26c. While each of front, middle, and rear portions 26a, 26b, 26c is shown as having a substantially rectangular cross-section, it is understood that each such portion may have an elliptical, rounded or cylindrical cross-section and work equally as well.

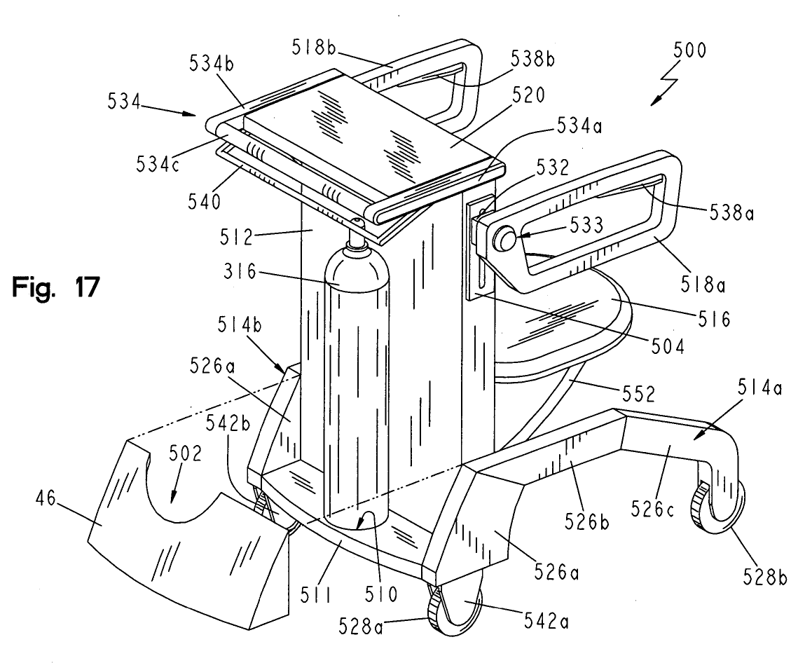

As shown, leg members 14a, 14b are of substantially one-piece construction in the embodiment shown in FIG. 1. Alternatively, as shown, for example, in FIG. 17, the middle portion 526b of leg members 514a, 514b is illustratively a welded square extrusion, while the front and rear portions 526a, 526c of leg members 514a, 514b are illustratively cast parts.

In one or more of the alternative embodiments, leg members 14a, 14b are shaped to fit substantially underneath a bed, such as a patient bed or hospital bed, in order to permit the patient transport apparatus 10 to be stored at the foot of the bed, or at the side of the bed, for example, while a patient is resting in the bed.

For example, middle portion 26b may be coupled to the end of rear portion 26a that is nearest base 11, so that the height of middle portion 26b off the ground is reduced. Alternatively or in addition, the length of each of front, middle, and rear portions 26a, 26b, and 26c may be individually adjustable to accommodate the dimensions of a particular bed or other hospital apparatus. Further, the angle defining the intersection of rear portion 26a and middle portion 26b, and/or the angle defining the intersection of middle portion 26b and front portion 26c, may also be adjusted, for example, to accommodate particular hospital or equipment configurations.

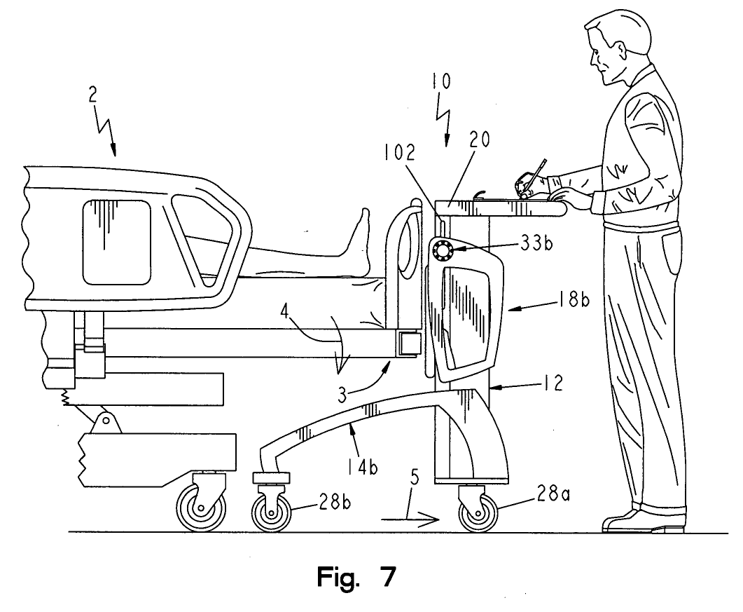

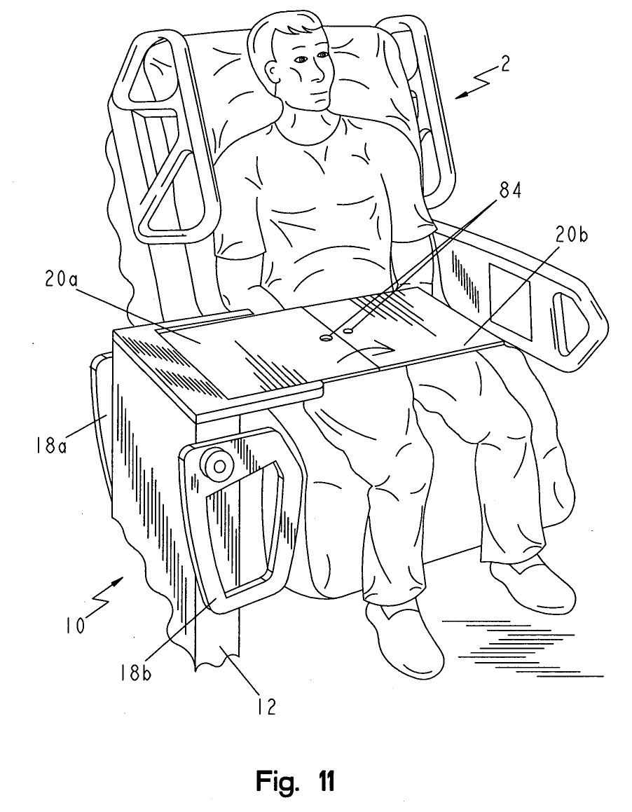

In at least one embodiment, leg members 14a, 14b are shaped to at least temporarily engage a foot section 3 of an articulating patient or hospital bed 3 if the foot section 3 is moved downwardly when the apparatus is positioned as shown in FIG. 7. The middle portion 26b of each leg member 14a, 14b provides a ramp surface which engages foot section 3 of the bed 2 when foot section 3 is moved from a horizontal position substantially parallel to the floor surface (shown in FIG. 7) to a vertical position substantially perpendicular to the floor surface, for example, when the hospital bed is adjusted so that a patient is moved into an upright chair position shown in FIG. 11. If foot section 3 is pivoted downwardly in the direction of arrow 4 in FIG. 7, foot section 3 engages leg members 14a, 14b, the patient support apparatus is gently urged away from the hospital bed 2 in the direction of arrow 5. Thus, the floor area in front of foot section 3 of the bed is cleared of the patient transport apparatus 10, allowing the patient to exit the bed adjacent foot section 3.

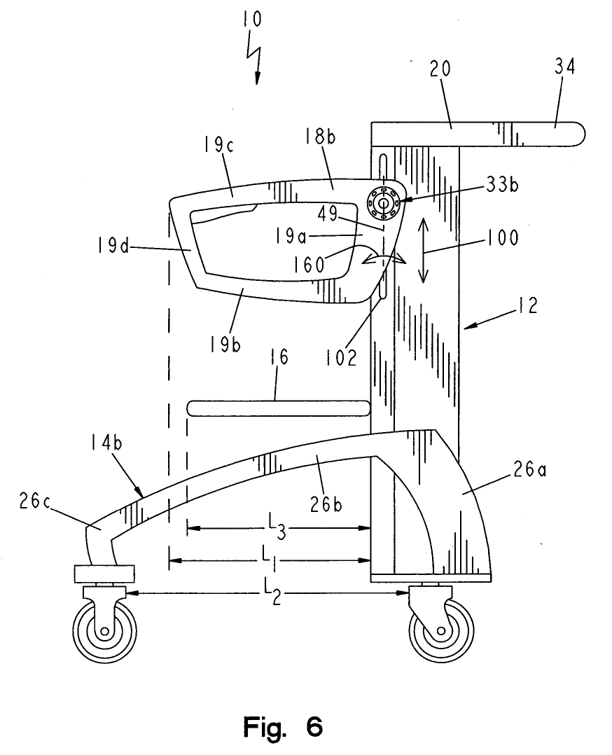

As best shown in FIG. 6, the length L₂ of leg members 14a, 14b generally extends outwardly beyond the length L₁ of arm members 18a, 18b and the length L₃ of seat 16. As shown, middle portions 26b of leg members 14a, 14b are elongated in order for leg members 14a, 14b to extend outward beyond arm members 18a, 18b and seat 16.

A pair of rear wheels or casters 28a is coupled to base 11 in the embodiment of FIGS. 1-7. In other embodiments, rear wheels 28a are coupled to bottom end 22 of vertical frame 12 and/or to rear portions 26a of leg members 14a, 14b. See, for example, FIGS. 14, 15, 17, and 19. In general, rear wheels 28a rotate bidirectionally around axis 27a to provide for forward and backward motion of the apparatus 10. Alternatively, rear wheels/casters 28a swivel or otherwise provide for multidirectional movement of the apparatus 10.

A front wheel 28b is coupled to each front portion 26c of each of leg members 14a and 14b. Front wheels 28b rotate bidirectionally around axis 27b. Alternatively or in addition, front wheels 28b swivel or otherwise provide for multidirectional movement of the apparatus 10. In the embodiment of FIG. 1, front wheels 28b are coupled to horizontal plates 29 via yokes 39, and horizontal plates 29 are coupled to front portions 26c of leg members 14a, 14b. It is understood that horizontal plates 29 may be continuous with front portion 26c, such that horizontal plates 29 and leg members 14a, 14b are of singular or substantially singular construction.

As shown in the illustrated embodiments, rear wheels 28a and front wheels 28b are of substantially the same size and spaced apart generally parallel in proportion to the dimensions of vertical frame 12 and leg members 14a, 14b. However, it is understood that rear wheels 28a may be larger, smaller, wider, narrower, taller, or shorter than front wheels 28b as may be appropriate or desirable in a particular embodiment. It is also understood that the front and rear wheels 28a, 28b adjacent first side 13a and the front and rear wheels 28a, 28b adjacent second side 13b may not be parallel to one another. For instance, the distance between front wheels 28b may be narrower or wider than the distance between rear wheels 28a, i.e., for stability reasons or to allow the patients' legs and feet more room to maneuver within the area between leg members 14a, 14b.

Referring back to FIG. 1, foot supports 30a, 30b are provided to support a patient's feet when the patient is seated in apparatus 10. Each foot support 30a, 30b is coupled to yoke 39 of each leg member 14a, 14b, respectively, via posts 25. As shown, posts 25 are pivotably coupled to the leg members 14a, 14b so that foot supports 30a, 30b can be rotated up and/or folded back against leg members 14a, 14b, so as not to obstruct the area between leg members 14a, 14b when not in use. In this regard, posts 25 are pivotably coupled to yokes 39 so that they rotate around axis 27b. Yokes 39 are coupled to horizontal plates 29.

Also, foot supports 30a, 30b are pivotably coupled to posts 25 so that foot supports 30a, 30b rotate about axis 31. Alternatively, foot supports 30a, 30b are fixedly coupled to posts 25 and posts 25 are pivotably coupled to yokes 39 to rotate around axis 31 that runs longitudinally through each post 25. Stops 37a, 37b (37a not shown) are coupled to yokes 39 below posts 25. Stops 37a, 37b stop the downward rotation of foot supports 30a, 30b around axis 27b at an outwardly extended position, as shown in FIG. 1, which enables the patient to rest his or her feet on foot supports 30a, 30b. Additional stops (not shown) limit pivotal movement of foot supports 30a, 30b about posts 25. In another embodiment, posts 25, foot supports 30a, 30b, and stops 37a, 37b are removable from leg members 14a, 14b.

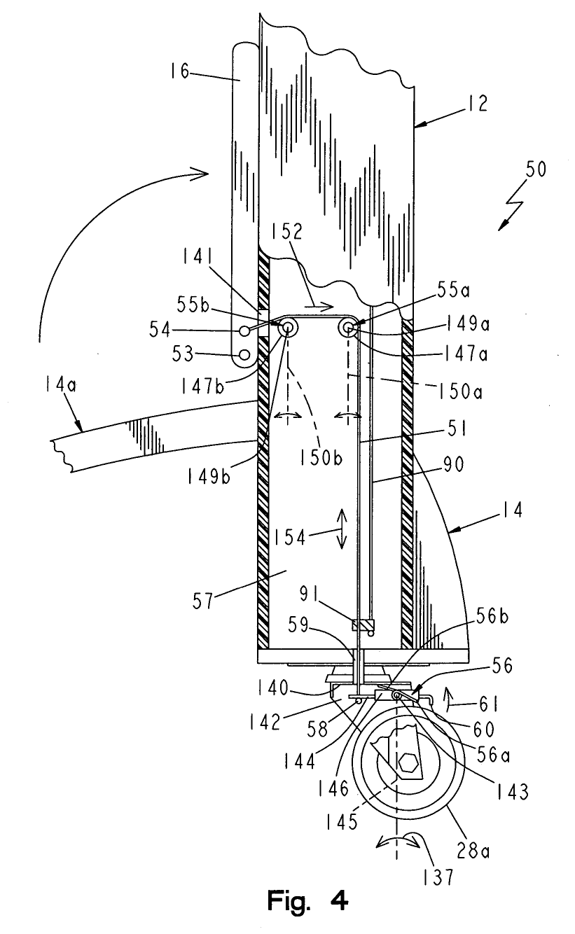

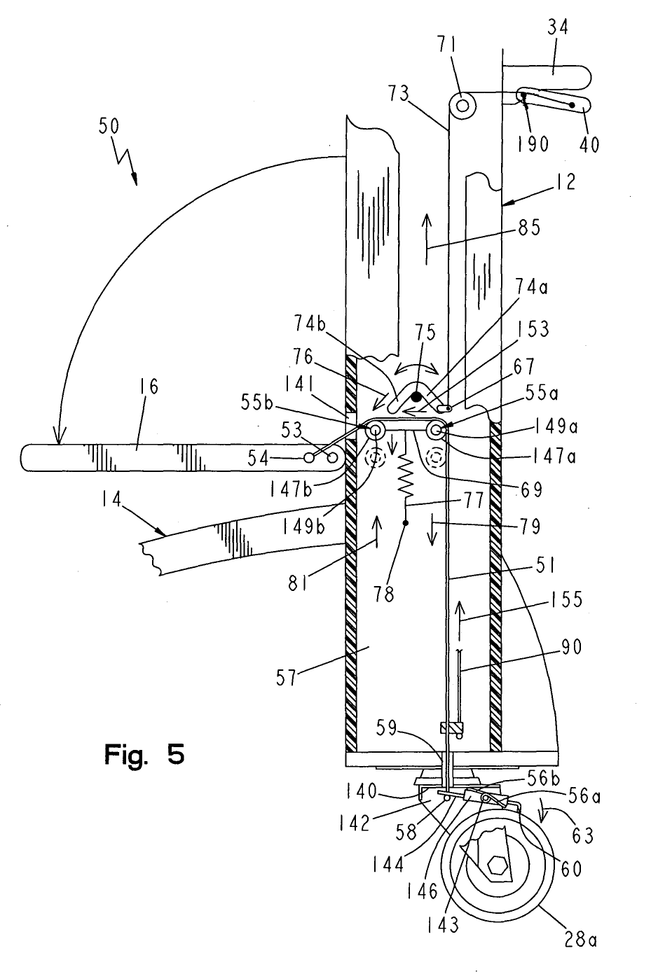

As shown in FIG. 1, seat 16 is coupled to vertical frame 12 at about the middle portion 24 of vertical frame 12. Seat support 52 (best shown in FIG. 3) is used to couple seat 16 to vertical frame 12, as further described below. In one embodiment, seat support 52 is a fixed seat support. In another embodiment, seat support 52 is a sliding seat support. As shown in FIGS. 1 and 3, seat 16 is pivotably coupled to frame 12 so that it can be pivoted or folded upwardly toward vertical frame 12 to a storage position when not in use (FIG. 3), and rotated or pivoted downwardly away from vertical frame 12 to a use position, substantially perpendicular to vertical frame 12, when in use (FIG. 1). As further described below, in one embodiment, a braking mechanism 50 is coupled to seat 16 such that movement of seat 16 from the storage position to the use position activates braking mechanism 50 (FIGS. 4 and 5).

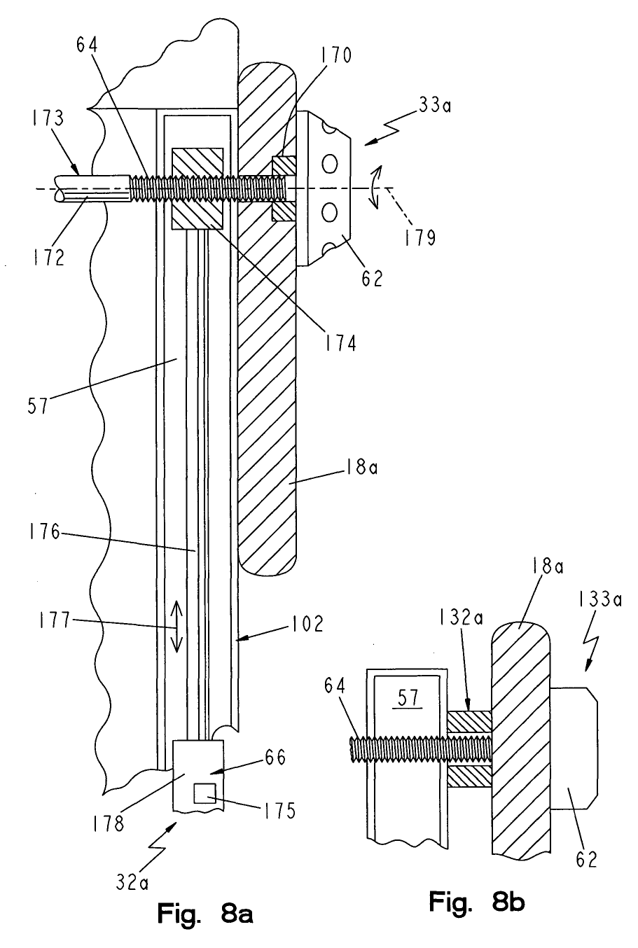

First and second arm members 18a, 18b are coupled to first and second sides 13a, 13b, respectively, of vertical frame 12 by coupling mechanisms 133a and 133b (133b not shown in FIG. 1). In the embodiment of FIGS. 1-3, spacers 132a, 132b are provided between arm members 18a, 18b and frame 12. However, as shown in FIG. 8a, in alternative embodiments, spacers 132a, 132b are not provided.

In the illustrated embodiments, arm members 18a, 18b include rear section 19a, lower arm section 19b extending substantially perpendicularly outward from rear section 19a, upper arm section 19c extending substantially perpendicularly outward from rear section 19a and positioned above lower arm section 19b and spaced apart from lower arm section 19b, and front section 19d connecting lower arm section 19b and upper arm section 19c and spaced apart from rear section 19a. It is understood that other arm configurations may be used in accordance with the present invention, such as is shown in FIG. 14, described below.

As shown in FIG. 1, patient brake mechanisms 38a, 38b are coupled to or integrated with upper arm sections 19c of arm members 18a, 18b, respectively. Brake mechanisms 38a, 38b are positioned underneath upper arm section 19c so that persons resting their hands or arms on arm members 18a, 18b can grip brake mechanisms 38a, 38b with their hands. It is understood, however, that brake mechanisms 38a, 38b could be located on or within rear arm section 19a, lower arm section 19b, or front arm section 19d, as may be desirable in a particular embodiment. Operation of patient brake mechanisms 38a, 38b is discussed further below.

First and second arm members 18a, 18b are rotatable 360 degrees around a horizontal axis 49 extending perpendicularly through coupling mechanisms 133a, 133b. First and second arm members 18a, 18b, are also vertically movable along first and second sides 13a, 13b, respectively, of vertical frame 12 in the directions of bi-directional arrow 100, as shown in FIG. 6, so that the height of arm members 18a, 18b can be adjusted for the size of the patient.

Also shown in FIG. 1 are support surface 20 and handle 34, which are coupled to top end 36 of vertical frame 12. Support surface 20 supports various patient and/or caregiver items such as medications, beverages, personal effects, and/or a food tray, and also may be used as a work surface, for example, to write notes or prepare or update medical records. Alternatively or in addition, a computer monitor, digital display screen, or portable computing device 192 is provided in or on support surface 20. See, for example, FIG. 15. The monitor or display screen is coupled to a computer located within vertical frame 12, or, alternatively, the computing device may be wirelessly connected to a network as is known in the art.

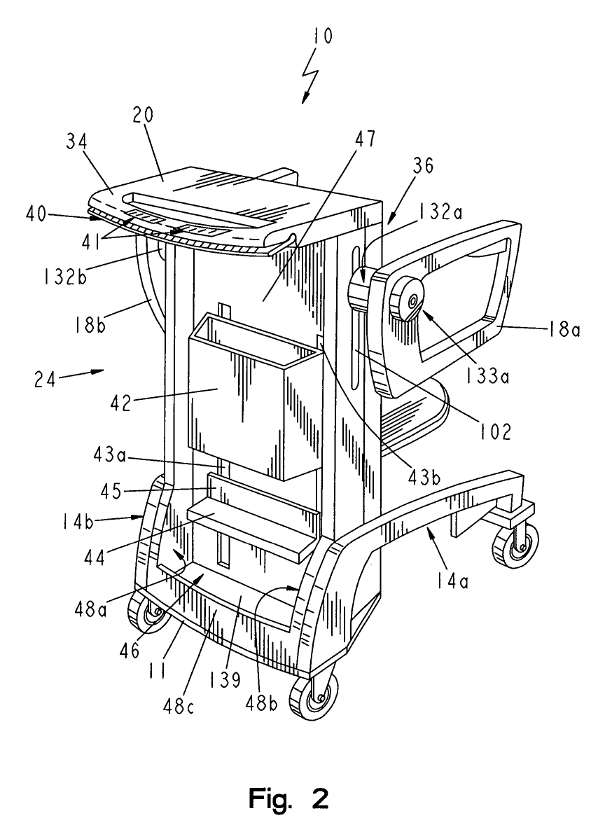

Handle 34 is provided for a caregiver or other person to push the patient transport apparatus, particularly when a patient is seated therein. As shown in FIG. 1, handle 34 includes a first side bar 35c, a second side bar 35b, and a center bar 35a. Handle 34 is coupled to support surface 20 and frame 12 at first side bar 35c and second side bar 35b. First and second side bars 35b, 35c extend outwardly beyond the length of support surface 20, and center bar 35a is spaced apart from support surface 20 to allow persons to grip handle 34 without interference from surface 20. There are many possible variations on the configuration of handle bar 34, for example, a pair of bicycle or wheelchair-style grips could be used with bicycle-style hand brakes in lieu of the single handle 34, as shown in FIG. 14 and further described below. As discussed further below, brake release mechanism 40 and/or arm member position adjustment mechanism 41 (shown in FIG. 2) are integrated with handle 34 in certain embodiments.

FIG. 2 shows a view of the walker and transport chair apparatus 10 from the perspective of a caregiver or other person standing behind apparatus 10. In the illustrated embodiment, brake release mechanism 40 is integrated with handle 34, thus enabling a caregiver or other person to release braking mechanism 50 (FIG. 4) and transport apparatus 10, for example, to push a patient while the patient is seated on seat 16. When brake release mechanism 40 is pulled upwardly toward handle 34, or otherwise actuated, braking mechanism 50 is disengaged from wheels 28a. Brake release mechanism 40 is shown in more detail in FIG. 5, discussed below.

FIG. 2 also shows arm member position adjustment mechanisms 41. As shown in FIG. 2, arm member position adjustment mechanisms 41 illustratively include two push buttons each corresponding to one of arm members 18a, 18b. Arm member position adjustment mechanisms 41 may alternatively be a lever, switch, or similar activating mechanism. Arm member position adjustment mechanisms 41 are integrated with handle 34. Arm member position adjustment mechanisms 41 are coupled to vertical coupling mechanism 32a via a cable (not shown) permitting a caregiver or other person to raise and lower arm members 18a, 18b vertically in accordance with the height and/or size of the patient. By activating (e.g., by applying pressure to) either of arm member position adjustment mechanisms 41, vertical coupling mechanism 32a (FIG. 8a) is released, enabling either arm member 18a or 18b to slide upward or downward within vertical slot 102. The push buttons 41 of FIG. 2 are actuated independently, i.e., pressing one of push buttons 41 only releases the vertical coupling mechanism for the corresponding arm member 18a, 18b. However, alternatively, push buttons 41 are mechanically linked so that pressing one of push buttons 41 releases the vertical coupling mechanism for both arm members 18a, 18b, simultaneously. The operation of vertical coupling mechanism 32a is further described below.

In an alternative embodiment, the middle portion 24 and/or top end 36 of vertical frame 12, along with arm members 18a, 18b, is raised or lowered when arm member adjustment mechanisms 41 release vertical coupling mechanism 32a as needed, to suit the height and/or size of the patient.

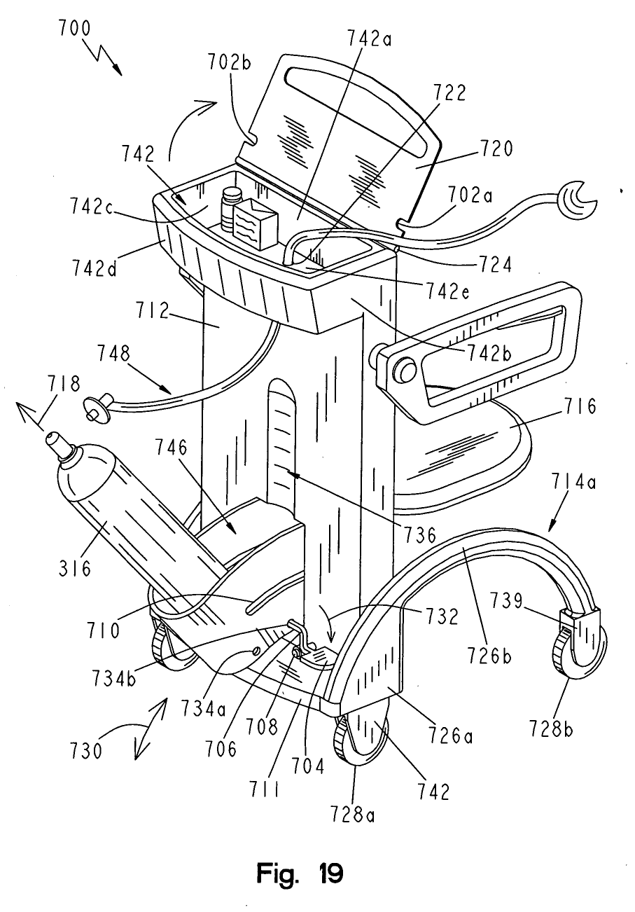

Also shown in FIG. 2 are first storage receptacle 42, storage shelf 44, and second storage receptacle 46. First storage receptacle 42 and storage shelf 44 are coupled to rear center wall 47 of frame 12 via vertically-adjustable brackets (not shown) which are slidingly coupled to receptacle height adjustment mechanisms 43a, 43b. In this way, the position of receptacle 42 and shelf 44 can be adjusted as needed for storage of various-sized items. Alternatively, storage shelf 44 is coupled to rear center wall 47 via shelf mount 45. Second storage receptacle 46 is illustratively molded into frame 12. Second storage receptacle 46 is illustratively formed by a floor surface 139, side walls 48a, 48b, front wall 48c, and center wall 47. In the illustrated embodiment, first storage receptacle 42 is sized to store patient files and other items, while second storage receptacle 46 is sized to house larger items, such as an oxygen tank or other equipment (see FIGS. 17, 19).

FIG. 3 shows seat 16 in an upwardly pivoted storage position, substantially parallel to front center wall 106 of frame 12. As discussed above, seat support 52 provides for the attachment of seat 16 to frame 12 and enables seat 16 to assume a plurality of positions, including an upward or generally vertical storage position and a downward or generally horizontal use position. In the illustrated embodiment, seat support 52 is a sliding support mechanism.

As illustrated in FIG. 3, seat support 52 includes support members 122a, 122b coupled to support mounts 124a, 124b (124a not shown). Support mounts 124a, 124b are coupled to bottom surface 104 of seat 16 via couplers 108a, 108b, 109a, 109b (108a and 109a not shown). Support members 122a, 122b include a longitudinal slot 112a, 112b in which lugs 110a, 1 10b (110a not shown), are positioned. Lugs 110a, 110b are coupled to support arms 116a, 116b such that movement of seat 16 causes lugs 110a, 110b to slide within slots 112a, 112b in the direction of arrow 128. When seat 16 rotates downwardly in the direction of arrow 125, lugs 110a, 110b slide toward front ends 126a, 126b of slots 112a, 112b, and support arms 116a, 116b extend outward away from frame 12 to support seat 16 in the downwardly pivoted use position.

Support arms 116a, 116b are pivotably coupled to center mount 120 via couplers 118a, 118b so that they rotate around axis 136. Center mount 120 is coupled to front center wall 106 near bottom end 22 of vertical frame 12.

Also shown in FIG. 3 are side seat brackets 114a, 114b which are coupled to bottom surface 104 of seat 16 on each side of seat support 52, by mounts 134a, 134b. Seat brackets 114a, 114b are pivotably coupled to frame brackets 130a, 130b via couplers 131a, 131b so that side seat brackets 114a, 114b rotate around axis 138. In this manner, side seat brackets 114a, 114b pivotably couple seat 16 to frame 12 in the embodiment of FIG. 3. It is understood that other suitable mechanisms for pivotably coupling seat 16 to frame 12, which are well known in the art, would work equally as well.

In FIGS. 4 and 5, braking mechanism 50 is shown in greater detail. FIGS. 4 and 5 show a side view of frame 12, leg member 14a, and rear wheel 28a, with portions cut away to show braking mechanism 50. Braking mechanism 50 includes cable 51 coupled to seat 16 by a first cable coupler 54. Cable 51 extends through an aperture 141 in frame 12 and over cable supports 55a, 55b located in an interior region 57 of frame 12. A second end of cable 51 extends through stem 59 and is coupled to brake lever portion 144 by cable coupler 58. A brake body 146 is pivotably coupled to yoke 142 by pivot connection 143. A torsion spring 56 includes arms 56a, 56b which engage brake body 146 and top plate 140, respectively, to bias brake member 60 upwardly in the direction of arrow 61.

Cable 51 is coupled to seat 16 via first cable coupler 54, and coupled to brake lever portion 144 of brake member 60 via second coupler 58. Cable supports 55a, 55b support cable 51 as it extends inwardly and downwardly in interior region 57 of frame 12 so that there is little to no slack in cable 51. As shown in FIG. 4, first and second cable supports 55a, 55b include couplers 149a, 149b, which couple supports 55a, 55b to the interior side of walls 48a, 48b or other support structure within interior region 57. Couplers 149a, 149b are surrounded by rotary couplers 147a, 147b, which rotate around axes 150a, 150b, which extend perpendicularly to frame 12 (into the page of FIG. 4), respectively, to permit movement of cable 51 in the directions of arrows 152 and 154. Cable 51 extends downwardly from seat 16 through aperture 141, interior region 57, hollow stem 59 and rear brake lever portion 144 of brake mechanism 50. Top plate 140 of yoke 142 is coupled to the wheel end of stem 59, and supports rear portion of torsion spring 56b. Also shown in FIG. 4 is aperture 53, which may be used in connection with a coupler to couple a seat bracket 114a, 114b to seat 16, or otherwise to pivotably couple seat 16 to frame 12.

In FIG. 4, seat 16 is shown in a generally upward, vertical, or storage position, substantially parallel to frame 12. As shown in FIG. 5, when seat 16 is moved from the storage position to a use position, cable 51 is pulled upwardly in the direction of arrows 153, 155, causing the brake body 146 to rotate downward toward wheel 28a in the direction of arrow 63. This motion causes brake member 60 to engage rear wheel 28a and slow the rotary motion of wheel 28a. Thus, braking mechanism 50 aids the operator of apparatus 10 in stopping the motion of apparatus 10, and in keeping apparatus 10 stationary while a person is seated on seat 16. Referring back to FIG. 4, when seat 16 is moved back to the storage position from the use position, cable 51 moves downwardly in the direction of arrow 154. Therefore, torsion spring 56 alternately rotates brake body 146 about axis 145 in the directions of double-headed arrow 137, to either engage brake member 60 or release brake member 60 and permit wheel 28a to rotate.

As mentioned above, a hand-operated brake release mechanism 40 is provided for releasing braking mechanism 50. In the embodiment of FIG. 5, brake release mechanism 40 is a lever pivotably coupled to handle 34. Alternatively, brake release mechanism is a push button or other suitable activating mechanism known in the art.

As shown diagrammatically in FIG. 5, brake release mechanism 40 is coupled to first end of mechanical linkage 74a via cable 73 and coupler 67. Cable 73 extends upwardly through handle 34, over pivot coupler 190 and into brake release mechanism 40, where its end is fixed inside the interior region of brake mechanism 40. Cable 73 is supported by third cable support 71, which is coupled to interior portion 57 of top end 36 of frame 12. Mechanical linkage 74a, 74b is pivotably coupled inside interior region 57 via pivot connector 75. When brake release mechanism 40 is activated, e.g., by pulling lever 40 in a downward or outward direction away from handle 34, cable 73 is pulled upwardly in the direction of arrow 85. This action causes first end of mechanical linkage 74a to pivot upwardly in the direction of arrow 85, and second end of mechanical linkage 74b to pivot downwardly in the direction of arrow 76.

When second end 74b pivots downwardly, it engages the first and second cable supports 55a, 55b and moves them downward in the direction of arrow 79. Illustratively, cable supports 55a, 55b are normally biased upwardly in the direction of arrow 81 by a spring mechanism 77 coupled to cable supports 55a, 55b via a coupler 69. Spring mechanism 79 is coupled to a support (not shown) within interior region 57 via coupler is 78. Spring 77 is compressed when second end 74b contacts and moves the support 55a, 55b downwardly. Cable supports 55a, 55b illustratively move to the positions shown in phantom in FIG. 5. As a result, tension in cable 51 is released, and brake member 60 is rotated upwardly by spring 143 and thus disengages from wheel 28a as shown in FIG. 4. When brake release mechanism 40 is not actuated, spring mechanism 77 pushes cable supports 55a, 55b upwardly in the direction of arrow 81. This causes the brake member 60 to engage the wheel as shown in FIG. 5. Spring 77 causes second end 74b of the linkage to pivot upwardly, disengaging cable supports 55a, 55b and causing tension to be restored in cable 51 as the cable supports 55a, 55b move back to the solid line position of FIG. 5.

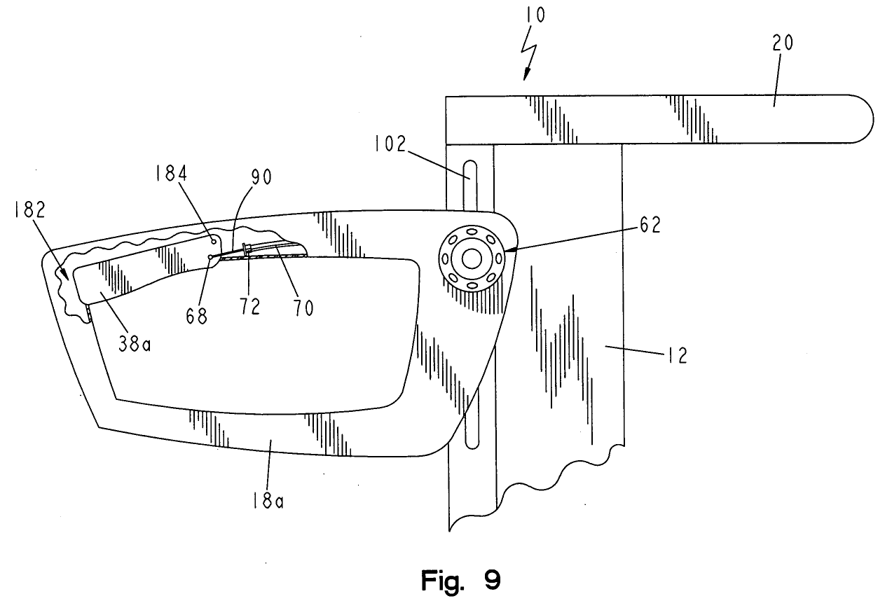

Also shown in FIGS. 4 and 5 is cable 90. Cable 90 couples either of patient brake mechanisms 38a, 38b to cable 51 via coupler 91, so that when patient brake mechanism 38a, 38b is activated, cable 90 is pulled upwardly toward the corresponding arm member 18a, 18b, increasing tension in cable 51 to activate the corresponding brake 60 as described above. When tension is released from brake mechanism 38a, 38b, the corresponding cable 90 is relaxed to release the corresponding brake 60 as described above. Each cable 90 is coupled to the respective patient brake mechanism 38a, 38b as shown in FIG. 9, described below. While not shown, it is understood that patient brake mechanism 38a, 38b is implemented on both of arm members 18a, 18b, and brake mechanism 50 is implemented on one or both of rear wheels 28a.

FIG. 6 shows a side view of the embodiment of FIG. 1, with seat 16 in the downward, horizontal, or use position, substantially perpendicular to frame 12. As best shown in FIG. 6, arm member 18 has a modified rectangular or elliptical shape and leg member 14 has a middle portion 26b, which is longer than either front portion 26c or rear portion 26a. Also, in the illustrated embodiment, length L₁ of arm member 18 is less than length L₂ of leg member 14, for increased stability of apparatus 10. Length L₂ is also longer than length L₃ of seat 16.

In exemplary embodiments, upper arm sections 19c of arm members 18a, 18b are biased slightly upward so that front sections 19d is elevated with respect to rear sections 19a, to counter the weight of the hand or arm of the patient. In one embodiment, this is accomplished by rotating arm members 18a, 18b upwardly around axis 49 (extending into the page of FIG. 6). In alternative embodiments, a cushioned layer of foam, fabric or other material is provided on upper arm sections 19c. In other embodiments, arm members 18a, 18b are bicycle or wheelchair style handlebars extending horizontally away from frame 12, substantially perpendicular to frame 12.

FIG. 6 also shows that rotary coupling mechanisms 33a, 33b (33a not shown) permit arm members 18a, 18b to rotate 360 degrees around axis 49 in the directions of bi-directional arrow 160. As shown in FIG. 7, arm members 18a, 18b are rotated downwardly toward frame 12 into a generally vertical or storage position, substantially parallel to frame 12, for example, to allow apparatus 10 to be positioned next to a bed 2. When configured as shown in FIG. 7, support surface 20 can be used as a convenient work surface, for example, by a caregiver taking notes on a patient's condition.

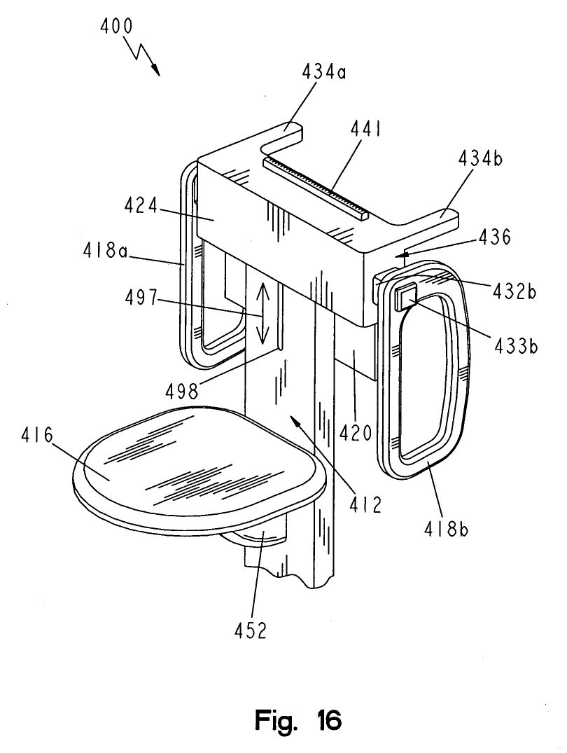

In the exemplary embodiments of FIGS. 6-9, vertical slots 102 in first and second sides 13a, 13b of frame 12 are provided. Vertical slots 102 enable arm members 18a, 18b, rotary coupling mechanisms 33a, 33b, and vertical coupling mechanisms 32a, 32b (FIG. 8a; 32b not shown) to move vertically with respect to frame 12 in the directions of arrow 100 (FIG. 6), in order to adjust the height of each of arm members 18a, 18b according to the size of the patient. In other embodiments, such as is shown in FIGS. 1-3 and 10-13, vertical slots 102 are not provided, either because vertical movement of the frame 12 and/or arm members 18a, 18b is not provided in those embodiments, or because such vertical movement is accomplished by adjustment of middle portion 24 and/or top end 36 of frame 12 as described above and shown in the embodiment of FIG. 16.

FIGS. 8a and 8b show cross-sectional views of exemplary embodiments of rotary coupling mechanisms 33a, 33b (33b not shown) and 133a, 133b (133b not shown), and vertical coupling mechanisms 32a, 32b (32b not shown). FIG. 8a shows the coupling mechanisms in an embodiment without spacers 132a, 132b, and FIG. 8b shows an embodiment with spacers 132a, 132b. Rotary coupling mechanisms 33a, 33b and 133a, 133b can be any suitable rotary locking mechanism known in the art, such as, for example, a friction clutch mechanism. In the illustrated embodiments, rotary coupling mechanisms 33a, 33b and 133a, 133b are “thumb screw” type locking mechanisms, which lock arm members 18a, 18b into a static position or release arm members 18a, 18b for rotation. As shown in FIG. 8a, rotary coupling mechanisms 33a, 33b include a tightening knob 62 coupled to a rod 173 and secured thereto via shoulder 170. Threaded portion 64 of rod 173 extends through arm members 18a, 18b, and unthreaded portion 172 extends into interior region 57 of frame 12. The embodiment of FIG. 8b is similar, except that spacer 132a is positioned between arm member 18a and tightening knob 62.

Knob 62 is positioned on the outside of arm members 18a, 18b for ease of access. When the operator of apparatus 10 tightens knob 62 by rotating knob 62 clockwise around axis 179, rod 173 is driven inwardly into frame 12 to hold arm member 18 in place. Detents or other holders may be used, if necessary, to hold the arms 18a, 18b in a selected orientation. When the operator loosens knob 62 by rotating knob 62 counterclockwise around axis 179, rod 173 is driven outward, creating space between frame 12 and arm member 18, and arm member 18 becomes rotatable around axis 179 through rod 173. Illustratively, knob 62 is formed of neoprene rubber or other suitable material for ease of grip.

Also shown in FIG. 8a is vertical coupling mechanism 32a, located in interior region 57 of frame 12. While not shown in FIG. 8b, it is understood that the embodiment of FIG. 8b also includes vertical coupling mechanism 32b. Vertical coupling mechanism 32a includes gas spring/lock 66, which operates to raise and lower arm members 18a, 18b to adjust the vertical height of arm members 18a, 18b with respect to frame 12. The height of arm members 18a, 18b is adjusted by releasing vertical coupling mechanism 32a. This is illustratively accomplished by depressing arm member position adjustment mechanism 41 (FIG. 2), located on handle 34. Mechanism 41 illustratively releases the gas spring/locks 66 and permits movement of the arm members 18a, 18b. In this way, the position of arm member 18 is adjustable to support the hands of a patient when the patient is standing, and to support the arms of the patient when the patient is seated.

Vertical coupling mechanism 32a includes threaded nut 174 coupled to a piston 176 of gas spring 66. Nut 174 meshes with threaded portion 64 so that the entire rotary coupling mechanism 33a, as well as arm members 18a, 18b, are moved up or down via slot 102 in the direction of double-headed arrow 177 when vertical coupling mechanism 32a is activated. Gas spring 66 includes actuator 175 which selectively releases the piston 176 for movement relative to the cylinder 178. Actuator 175 is coupled to adjustment mechanism 41 by a suitable connection such as a bowden wire or cable. When an operator actuates the actuator 175, gas lock 66 is released and piston 176 is movable relative to cylinder 178 to adjust the vertical position of arms 18a, 18b. When an operator releases actuator 175, gas spring 66 locks the piston 176 in place relative to the cylinder to hold the arms 18a, 18b in place. Although a gas spring 66 is illustrated in FIG. 8, it is understood that any type of conventional locking mechanism can be used to secure handles 18a, 18b to the vertical frame 12. For instance, a ball screw, hydraulic cylinder, pneumatic cylinder, mech-lock or other suitable locking mechanism can be used.

FIG. 9 shows one of arm members 18a with a portion cut away to reveal in greater detail the interior cavity 182 of arm members 18a and/or 18b (18b not shown) of one embodiment of the present invention. In interior cavity 182, brake mechanisms 38a, 38b (38b not shown) are coupled to a cable 90 via coupler 68. Brake mechanisms 38a, 38b operate to brake wheels 28a when actuated by a person using the walker or seated in seat 16. Cable 90 is coupled to brake lever portion 144 of brake member 60 through coupler 91, as shown in FIGS. 4 and 5. Cable 90 is at least partially surrounded by a protective sheath or tube 70 made of plastic or other suitable material, which is held in place by collar 72. When at least one of brake mechanisms 38a, 38b is gripped or pulled upward, cable 90 moves upwardly in the direction of arrow 155, brake lever portion 144 moves upwardly to the FIG. 5 position, and brake member 60 engages wheel 28a.

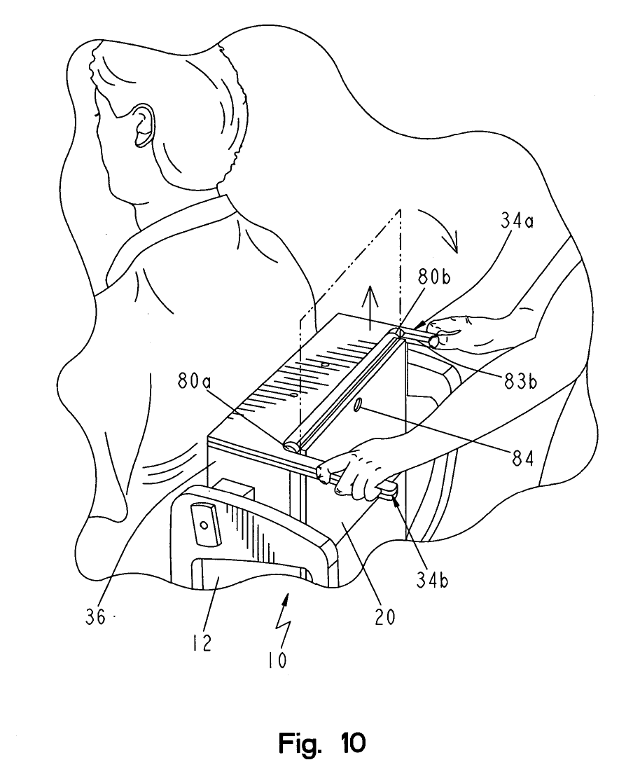

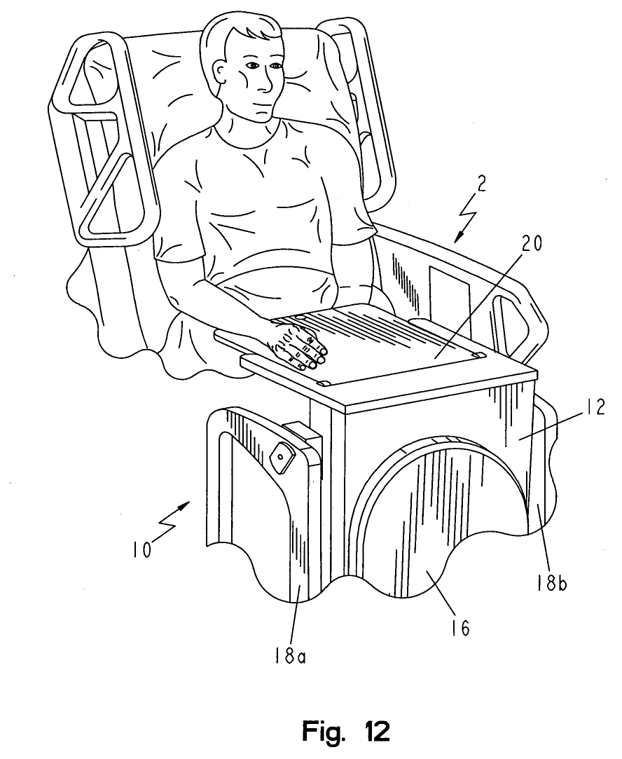

FIGS. 10-13 illustrate various configurations of a portable table feature of apparatus 10. FIG. 10 shows support surface 20 folded downwardly parallel to frame 12 in a storage position advantageous when support surface 20 is not in use. Support surface 20 is pivotably coupled to top end 36 of frame 12 by pins 80a and 80b, or other suitable coupler known in the art. To place support surface 20 into a use position, the operator of apparatus 10 grasps onto hold 84, pulls support surface 20 upward, and then rotates support surface 20 downwardly so that it rests on flanges 83a, 83b (83a not shown) to form a horizontal surface as shown in FIGS. 11 and 12.

FIG. 11 shows the support surface 20 of FIG. 10 being used by a patient seated in bed 2, with apparatus 10 positioned to the side of bed 2. As shown in FIG. 11, support surface 20 is in a fully extended position over the patient's lap. Portion 20b of support surface 20 is illustratively folded outwardly away from portion 20a. In another embodiment, portion 20b slides relative to portion 20a or telescopes into an out of portion 20a. Arm members 18a, 18b are rotated downwardly parallel to frame 12 as described above so that apparatus 10 can be positioned next to bed 2. In this manner, apparatus 10 serves as a portable side table or tray when not in use as a walker or transport chair.

FIG. 12 shows the embodiment of FIG. 10 positioned in front of a patient seated in bed 2. Apparatus 10 is shown positioned at the foot end of bed 2 with arm members 18a, 18b in the downward storage position. Support surface 20 is shown in the folded position, toward the patient.

FIGS. 10-12 also shows an alternative embodiment of handle 34, which includes two substantially-identical bicycle or wheelchair style hand grips 34a, 34b. In the embodiment of FIGS. 10-12, hand grips 34a, 34b extend horizontally outward from top end 36 of frame 12.

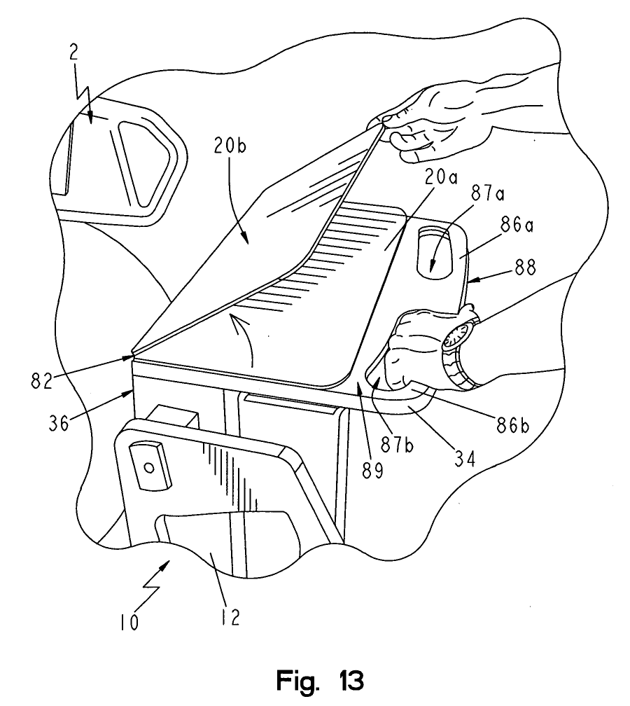

FIG. 13 shows another embodiment of support surface 20, wherein support surface 20 is coupled to frame 12 such that it sits atop of top end 36 adjacent to handle 34. In the illustrated embodiment, support surface 20 has two substantially identical sections 20a and 20b, which are hinged together at joint 82. Thus, support surface 20 can be used either in the folded position, with portion 20b folded on top of portion 20a, or in the fully extended position, with portion 20b folded out away from portion 20a. As discussed above, portion 20b can also slide or telescope outwardly relative to portion 20a.

FIG. 13 also shows an alternative embodiment of handle 34, wherein handle 34 comprises first and second handle sections 86a and 86b. Each of handle sections 86a, 86b includes an opening 87a, 87b between caregiver side 88 and frame side 89 of handle 34. Openings 87a, 87b are sized so that adult-sized fingers can fit therein when an operator or caregiver grasps caregiver side 88 of handle 34.

FIG. 14 shows another embodiment of the present invention. As shown in FIG. 14, apparatus 200 includes frame 212. Leg members 214a, 214b, arm members 218a, 218b, seat 216, support surface 220, and handles 234a, 234b are coupled to frame 212 to provide the patient transport apparatus 200 as shown.

Frame 210 includes an indented or recessed area 222, which is formed to correspond to the shape and contour of seat 216. Seat 216 is pivotably coupled to frame 210 via seat coupler 252, so that it may be moved upwardly in the direction of arrow 250 when not in use. When seat 216 is moved into the upward position, it is received by recessed area 222, so that it may be stored substantially within the perimeter of frame 210.

Seat 216 includes a base portion 256 and a top portion 258 supported by base portion 256. Base portion 256 may be constructed from any plastic, metal, wood, composite, or other suitable material. Top portion 258 is illustratively a bladder, cushion, fiber layer, or molded plastic layer, or other suitable material, that is suitable for supporting a person seated on seat 216, as is well known in the art. While not specifically shown, it is understood that the seat-activated braking mechanism 50 discussed above may be included in the embodiment of FIG. 14.

Leg members 214a, 214b are pivotably coupled to first and second sides 213a, 213b via pivot coupler 260 so that they are movable upwardly toward first and second frame sides 213a, 213b in the direction of arrow 262. Such movement of leg members 214a, 214b places leg members 214a, 214b into a more convenient location for storing apparatus 210. As a result, apparatus 210 is able to assume a more compact position when it is not in use. Pivot coupler 260 is any suitable mechanical pivot coupler known in the art. Alternatively, leg members 214a, 214b are fixedly coupled to first and second sides 213a, 213b of frame 210, respectively, by a suitable adhesive or mechanical coupler known in the art.

As shown in FIG. 14, leg members 214a, 214b include rear, middle and front portions 226a, 226b, and 226c. Rear, middle and front portions 226a, 226b, and 226c are illustratively of substantially continuous construction. The angles defining the intersection of rear portion 226a and middle portion 226b, and the angles defining the intersection of middle portion 226b and front portion 226c are about 90 degrees or slightly greater than 90 degrees. However, it is understood that leg members 214a, 214b may assume any of the other configurations shown or disclosed herein.

Wheel pairs 228a and 228b are coupled to leg members 214a, 214b. As shown, rear wheels 228a are coupled to rear coupling portions 208a, 208b of rear portions 226a of leg members 214a, 214b, and front wheels 228b are coupled to front coupling portions 227a, 227b of front portions 226c of leg members 214a, 214b, so that wheels 228a, 228b are bidirectionally rotatable. It is understood that either front wheels 228b or rear wheels 228a may be pivotably coupled to their respective coupling portions 208a, 208b, 214a, 214b in order to swivel.

Foot plates 230a, 230b have coupling portions 264a, 264b, which are pivotably coupled to front portions 226c of leg members 214a, 214b via couplers 225 as shown. Couplers 225 extend through the middle of coupling portions 264a, 264b and the ends of couplers 225 are coupled to front portions 226c of leg members 214a, 214b. In this way, foot plates 230, 230b are rotatable around the center portions of couplers 225 in order to move in the directions shown by arrows 266, e.g., from an upward, substantially vertical position parallel to first and second sides 213a, 213b of frame 210 to a substantially horizontal position, and vice versa. Stops 268a, 268b are positioned on the inner surfaces of front portions 226c of leg members 214a, 214b to hold foot plates 230a, 230b in the substantially horizontal position when a patient places his or her feet on foot plates 230a, 230b. Stops 268a, 268b are a continuous molded portion of front portions 226c, or, alternatively, are a separate structure fixedly coupled to front portions 226 by an adhesive or mechanical coupler known in the art. Foot plates 230a, 230b can also pivot downwardly to rest against front portions 226c of leg members 214a, 214b, respectively, for storage.

Arm members 218a, 218b are coupled to first and second sides 213a, 213b of frame 210 via arm member couplers 206a, 206b (206a not shown). Arm member couplers 206a, 206b are configured to permit arm members 218a, 218b to rotate 360 degrees around an axis extending perpendicularly outward from the center of arm member couplers 206a, 206b, and also to allow the height of arm members 218a, 218b to be vertically adjusted, both as shown and described in connection with FIGS. 8a and 8b above.

Arm members 218a, 218b include grips 204a, 204b and brake mechanisms 238a, 238b. Grips 204a, 204b are formed of a foam, rubber, vinyl, or other similar material and are positioned over the ends of arm members 218a, 218b to provide a more comfortable grip for a patient holding onto arm members 218a, 218b. Brake mechanisms 238a, 238b are pivotably coupled to arm members 218a, 218b. Brake mechanisms 238a, 238b are each coupled to a cable (not shown) that extends through arm members 218a, 218b and frame sides 213a, 213b and connects to each of rear wheels 228a, such that when brake mechanisms 238a, 238b are pulled or moved upwardly toward grips 204a, 204b, tension in the cable increases causing a brake to be applied to rear wheels 228a, as shown and described above in connection with FIGS. 4, 5 and 9.

Handles 234a, 234b are coupled to the top end of frame 210, and extend in a substantially “L” or “J” shape in the opposite direction of seat 216, as shown. Arm member adjustment activators 240a, 240b are provided on or integrated with handles 234a, 234b. As illustrated, activators 240a, 240b are push buttons that when depressed, release the gas/spring lock on arm members 218a, 218b so that the vertical height of arm members 218a, 218b can be adjusted as described above. Handles 234a, 234b are made of any suitable foam, plastic, metal, wood, composite, or other suitable material and may be coated or covered with a protective material such as is used for grips 204a, 204b.

Support surface 220 is pivotably coupled to the top end of frame 210 between handles 234a, 234b by hinge 268. Support surface pivots upwardly in the direction of arrow 254 to reveal a storage receptacle 242 located in frame 210 below support surface 220. Storage receptacle 242 is continuously molded into frame 210, or, alternatively, is a separate compartment coupled to frame 210 underneath support surface 220 via any suitable adhesive or mechanical couplers known in the art.

FIG. 15 shows another embodiment of the present invention. In the embodiment of FIG. 15, patient transport apparatus 300 includes base 311, frame 312 coupled to and supported by base 311, and seat 308, arm members 318a, 318b, and support surface 320 coupled to frame 312 as shown.

Base 311 has a carved-out or indented region 310, which is shaped to receive the bottom end of oxygen tank 316. Indented region 310 thus holds oxygen tank 316 in place when apparatus 300 is in motion. A further retainer such as a strap or clamp (not shown) may also be used to secure tank 316 to frame 312 if needed.

Leg members 314a, 314b are coupled to base 311 via any suitable adhesive or mechanical coupler known in the art. Leg members 314a, 314b include rear portion 326a, middle portion 326b, and front portion 326c, which are of substantially continuous construction. Rear wheels/casters 328a are coupled to rear portion 326a of leg members 314a, 314b via stem 339, and are of the swivel type. Front wheels 328b are similarly coupled to front portion 326c of leg members 314a, 314b via stem 329, except that front wheels 328b do not swivel. Alternatively, front wheels 328b swivel and rear wheels 328a do not.

Seat 308 is pivotably coupled to frame 312 and supported by seat support 352. Seat support 352 operates similarly to seat support mechanism 52 described above (FIG. 3), except that no seat-activated braking mechanism is included.

Arm members 318a, 318b are coupled to first and second sides 313a, 313b of frame 312, respectively, via arm couplers 333a, 333b (333b not shown). As shown, arm members 318a, 318b have a substantially elliptical shape. Arm couplers 333a, 333b include each include a threaded nut 362, a screw 373, and a spacer 332. Each screw 373 extends through the respective nut 362, arm member 318a/318b, and spacer 332 into the respective side 313a/313b of frame 312. Spacer 332 is positioned between arm member 318a/318b and side 313a/313b of frame 312. Screw 373 is tightened by clockwise rotation, for example, using a screw driver, and loosened by counter-clockwise rotation. Loosening of screw 373 causes arm member 318a, 318b to be rotatable 360 degrees around an axis extending outward through the end of screw 373. Tightening of screw 373 causes arm member 318a, 318b to be fixed in a set position with respect to frame 312. While no brake mechanisms or arm member height adjustment mechanism's are shown in FIG. 15, it is understood that these features could be incorporated into the illustrated embodiment.

FIG. 15 also shows an on-board computing device 192 coupled to support surface 320. Computing device 192 is a portable, wireless computing device, such as a laptop or a Personal Digital Assistant, which is capable of being connected to a computer network wirelessly. Alternatively, computing device is a computer monitor or terminal coupled to a portable computer stored elsewhere within frame 312 or located remotely and accessed via a wireless or other suitable network known in the art. According to another alternative, computing device 192 is a self-contained unit such as a digital calculator.

In general, computing device 192 is used to record, store, update view and patient data, such as appointment schedules, test results, locating and tracking information, identification data, vital signs or symptom/diagnosis information, insurance information, health care provider information, emergency contact information, or other information about the patient or the patient's health. Computing device 192 is also or alternatively used by health care providers to communicate with nurses, physicians, technicians, or other hospital or health care personnel.

FIG. 16 shows an upper portion of yet another embodiment of the present invention. In the embodiment of FIG. 16, patient transport apparatus 400 includes a first frame portion 412 and a second frame portion 424. Second frame portion 424 is movably coupled to first frame portion 412 through slot 498 by a gas spring/lock mechanism similar to that shown in FIG. 8a and described above, so that the height of the entire second frame portion 424 may be adjusted upward or downward in the directions of arrow 497. Height adjustment actuator 441, illustratively located on the top surface of second frame portion 424, operates in a similar manner to the actuator 175 of FIG. 8a. As shown, height adjustment actuator 441 is a push-button actuator, such that the application of force to height adjustment actuator 441 releases the gas spring/lock mechanism, enabling second frame portion 424 to move upward or downward along slot 498.

Arm members 418a, 418b are coupled to second frame portion 424 via arm couplers 432a, 432b and 433a, 433b (432a, 433a not shown). Arm couplers 433a, 433b include a thumb-screw or similar mechanism so that arm members 418a, 418b can be rotated upwardly at least 90 degrees to a position substantially perpendicular to the longitudinal axis of first frame portion 412, so that a patient seated on seat 416 can rest his or her arms on arm members 418a, 418b.

Second frame portion 424 includes integrated handles 434a, 434b. As shown, handles 434a, 434b are substantially “I” shaped and extend outward from second frame portion 424 in the opposite direction of seat 416. Second frame portion 424 also includes support surface 420, which is hingedly coupled to the inner top portion of second frame portion 424, between handles 434a, 434b. Support surface 420 is hinged to second frame portion 424 so that it can rotate upwardly toward handles 434a, 434b to define a plane substantially perpendicular to a longitudinal axis of first frame portion 412, so that it is suitable for supporting papers, medical supplies or other items. Seat 416 is fixedly coupled to first frame portion 412 via seat support 452.

FIG. 17 shows a further embodiment of the present invention. The patient transport apparatus 500 of FIG. 17 includes a base 511 and a frame 512 coupled to base 511. Base 511 is formed to include a substantially circular indented region 510, which has a diameter at least large enough so that the indented region 510 can receive the bottom end of an oxygen supply tank 316. As shown, the width of base 511 is large enough so that all of the sides of base 511 extend beyond the area of the indented region 510. Shroud 46 is a protective covering for oxygen supply tank 316 and also helps keep oxygen supply tank 316 secured in place when apparatus 500 is in motion. Shroud 46 is formed to slide, snap, or otherwise lock into place above base 511 and between rear portions 526a of leg members 514a, 514b. Shroud 46 is illustratively a molded or vacuum-formed covering made of plastic, composite, metal, or other suitable material known in the art.

Leg members 514a, 514b each include front portion 526c, middle portion 526b, and rear portion 526a fixedly coupled together as shown using an adhesive, mechanical, or other suitable coupler known in the art. Alternatively, front, middle and rear portions 526c, 526b, and 526a are pivotably or hingedly coupled so that the angle defined by the intersection of rear portion 526a and middle 526b, and the angle defined by the intersection of middle portion 526b and front portion 526a, are adjustable to adapt to various hospital room or storage configurations.

Front wheels 528b are coupled to front portions 526c of leg members 514a, 514b so that they rotate bidirectionally in forward and backward directions with respect to apparatus 500. Rear wheels 528a are coupled to yokes 542a, 542b (542b not shown). Yokes 542a, 542b are coupled to rear portions 526c of leg members 514a, 514b.

Arm members 518a, 518b are coupled to frame 512 via coupling mechanisms 532a, 532b, 533a, 533b (532b, 533b not shown) in similar fashion as described above with respect to the other embodiments of rotary coupling mechanisms and vertical height adjustment mechanisms. Arm members 518a, 518b include brake mechanisms 538a, 538b, which operate similarly to brake mechanisms 38a, 38b describe above and shown in FIG. 9.

Support surface 520 is coupled to the top end of frame 512 and operates similarly to support surface 20 described above. Seat 516 is coupled to frame 512 via seat support 552, both of which may take the form of any of the above-described embodiments of such components.

Handle 534 includes first side 534a, second side 534b, and center section 534c. Brake release mechanism 540 is pivotably coupled to side sections 534a, 534b of handle 534 and operates similarly to brake release mechanism 40 described above.

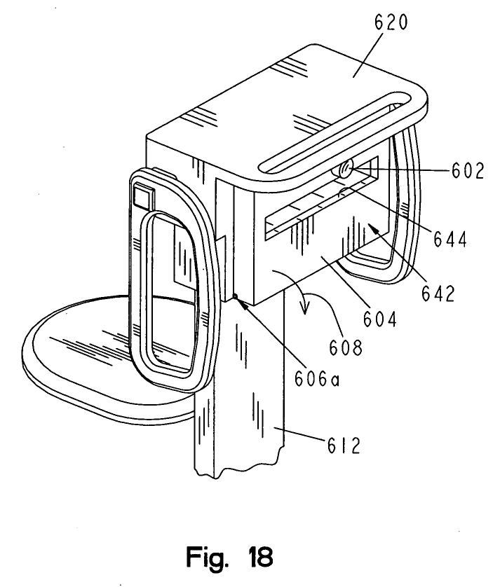

FIG. 18 shows an alternative embodiment of a storage receptacle for use in the present invention. Storage receptacle 642 is defined by the under side of support surface 620 and inner surfaces of frame 612 beneath support surface 620. Alternatively, storage receptacle 642 is a separate compartment coupled to frame 612 and/or support surface 620, underneath support surface 620.

Storage receptacle 642 includes front surface 604. Front surface 604 includes a slot or opening 644 through which articles, such as patient charts, can be inserted into storage receptacle 642 for confidential safekeeping. Front surface 604 is pivotably or hingedly coupled to frame 612 via couplers 606a, 606b (606b not shown) located adjacent the bottom portion of front surface 604. A knob, push-button, or similar activator 602 coupled to front surface 604 operates to pivot or rotate front surface 604 in the direction of arrow 608 to provide access to articles stored inside storage receptacle 542.

FIG. 19 shows another alternative embodiment of the present invention. Patient transport apparatus 700 particularly shows alternative configurations of leg members 714a, 714b (714b not shown), first storage receptacle 746, second storage receptacle 742, support surface 720, and frame 712.

Frame 712 includes a recessed or indented region 736, which substantially corresponds to the contour of oxygen supply tank 316, to facilitate secure storage of oxygen tank 316 within the contours of apparatus 700, especially while apparatus 700 is in motion.

As shown in FIG. 19, leg members 714a, 714b are of substantially one-piece rounded or arc-shaped construction similar to a semicircle. First portion 726a is coupled to base 711 and frame 712. Second portion 726b extends from first portion 726a and has a substantially cylindrical cross section. Yokes 739, 742 are coupled to second and first portions 726b, 726a, respectively, as shown, and wheels 728b, 728a are coupled to yokes 739, 742 respectively.

First storage receptacle 746 is substantially “U” shaped and configured to receive the bottom portion of an oxygen supply 316. First storage receptacle 746 is pivotably or hingedly coupled to base 711 and/or frame 712, so that it can be rotated outward away from apparatus 700 in the direction of arrow 712 to facilitate removal of oxygen supply 316. FIG. 19 shows first storage receptacle 746 in the outwardly rotated position, which is suitable for removing oxygen supply 316 from first storage receptacle 746 in the direction of arrow 718.

First storage receptacle 746 also includes a guide groove 710, an elongated indented or recessed area in its outer surface, which corresponds to a guide protrusion located inside frame 712 (not shown), which is shaped to fit within guide groove 710 and slides along guide groove 710 to support and facilitate smooth rotation of first storage receptacle 746.

A kick-button 704 is illustratively provided to permit the outward rotation of first storage receptacle 746. Kick-button 704 is pivotably coupled to frame 712 via pivot coupler 708. Kick-button 704 includes a rod 706 that is sized to correspond to locking slots 734a, 734b of first storage receptacle 746. When force is applied to kick-button 704 in the downwardly direction of arrow 732, rod 706 moves away from first storage receptacle 746 in the direction of arrow 732. This allows rod 706 to be removed from whichever slot 734a, 734b it had been previously inserted in, and allows first storage receptacle 746 to be released or unlocked to pivot either inwardly toward frame 712 or outwardly away from frame 712.

Pivot coupler 708 includes a spring mechanism (not shown), so that when pressure is released from kick-button 704, kick button 704 rotates in the opposite direction of arrow 732, so that when rod 706 aligns with either of apertures 734a, 734b, it is inserted into the corresponding aperture 734a, 734b with which it is aligned. When rod 706 is inserted in aperture 734b, first storage receptacle is locked in the downwardly or outwardly rotated position shown in FIG. 19. When rod 706 is inserted in aperture 734a, first storage receptacle 746 is locked in the upwardly or inwardly rotated position substantially within the contours of frame 712. It is understood that any other suitable rotating/locking mechanism may be used control the movement of first storage receptacle 746.

Second storage receptacle 742 is formed in the upper portion of frame 712 as shown in FIG. 19. Second storage receptacle 742 includes first, second, third, and fourth sides 742a, 742b, 742c and 742d, bottom side 742e, and an aperture 722 in bottom side 742. Aperture 722 is sized to allow an oxygen tube to pass through it. This facilitates connection of the oxygen mask apparatus 748 to oxygen supply 316.

Support surface 720 includes notches 702a, 702b on either side as shown (or in any other convenient location), which are sized to allow the tube portion of oxygen mask apparatus 748 to pass through either of them when support surface is closed down on top of second storage receptacle 742, allowing easy access to oxygen mask apparatus 748 by a patient using the patient transport apparatus 700. Instead of notches 702a, 702b, an aperture in support surface 720 corresponding to aperture 722 is provided, in an alternative embodiment, to facilitate connection of apparatus 748 to tank 316.

In general, it is understood that any of the individual components of any one embodiment of the present invention shown or disclosed herein may assume or take the form of any of the alternative embodiments shown or disclosed herein, or any other equivalent configurations of such components, to create further alternative embodiments of the present invention that fall within the scope and spirit of the present invention as presently perceived.

Although the present invention has been described in detail with reference to certain exemplary embodiments illustrated in the drawings, it is understood that variations and modifications exist with the scope and spirit of the present invention as defined and described in the following claims.

1. A patient transport apparatus, comprising:
a frame adapted to support a patient in a plurality of positions including a standing position and a seated position,
a plurality of wheels coupled to the frame,
a seat coupled to the frame above the plurality of wheels, the seat being movable from a generally vertical storage position to a generally horizontal seat position, and
a braking mechanism coupled to the seat, the braking mechanism being activated to brake at least one of the plurality of wheels when the seat is moved from the generally vertical storage position to the generally horizontal seat position.

2. The apparatus of claim 1, wherein the braking mechanism comprises a cable having a first end coupled to the seat and a second end coupled to a portion of the brake mechanism.

3. The apparatus of claim 2, wherein the braking mechanism further comprises a brake lever, a brake body, and a brake member, the brake lever is coupled to the second end of the cable, and the brake body is positioned between the brake lever and the brake member.

4. The apparatus of claim 3, wherein the braking mechanism further comprises a torsion spring having a first arm coupled to the brake body and a second arm coupled to a wheel.

5. The apparatus of claim 2, wherein the braking mechanism further comprises at least one cable support coupled to an interior region of the frame.

6. The apparatus of claim 1, wherein the plurality of wheels includes at least one rear wheel and the braking mechanism is coupled to the rear wheel.

7. The apparatus of claim 1, wherein the plurality of wheels includes at least one caster.

8. The apparatus of claim 1, wherein the frame has a top end and a bottom end spaced apart from the top end, and further comprising a handle coupled to the frame adjacent the top end.

9. The apparatus of claim 8, further comprising a brake release mechanism coupled to the handle, the brake release mechanism including an actuator coupled to the brake mechanism to release the brake on the at least one wheel.

10. The apparatus of claim 8, wherein the handle includes a pair of hand grips extending generally horizontally outwardly from the frame, and further comprising a brake activating mechanism coupled to at least one hand grip and a brake release mechanism coupled to at least one hand grip.

11. The apparatus of claim 1, further comprising a seat support coupled between the frame and the seat.

12. The apparatus of claim 11, wherein the seat support comprises a sliding support mechanism.

13. The apparatus of claim 1, further comprising first and second spaced apart arm members coupled to the frame.

14. The apparatus of claim 13, further comprising a brake release mechanism coupled to the first arm member, the brake release mechanism including an actuator coupled to the brake mechanism to release the brake on the at least one wheel.

15. The apparatus of claim 14, wherein the brake release mechanism comprises a mechanical linkage pivotably coupled to the frame, a cable coupled to the mechanical linkage, a cable support, and a spring coupled to the cable support.

16. The apparatus of claim 13, further comprising a brake activating mechanism coupled to the first arm member, the brake activating mechanism including an actuator coupled to the brake mechanism to activate the brake on the at least one wheel.

17. The apparatus of claim 16, wherein the brake activating mechanism comprises a mechanical linkage pivotably coupled to the frame, a cable coupled to the mechanical linkage, a cable support, and a spring coupled to the cable support.

18. A patient transport apparatus comprising:
a base,
a frame extending upward from the base, the frame being configured to support a patient,
first and second spaced apart arm members coupled to the frame, the first and second arm members having an arm member length,
first and second spaced apart leg members cantilevered from the base, the first and second leg members having a leg member length, the first and second leg members having an arcuate shape extending outwardly from the base such that the leg member length is greater than the arm member length.

19. The apparatus of claim 18, wherein the frame has a top end and a bottom end spaced apart from the top end and the first and second leg members are coupled to the bottom end.

20. The apparatus of claim 19, wherein each of the first and second leg members has a rear portion, a middle portion, and a front portion, and the rear portion is coupled to the bottom end of the frame.

21. The apparatus of claim 20, wherein the middle portion of the leg members is generally horizontally extending.

22. The apparatus of claim 20, further comprising a wheel coupled to the front portion of the leg members.

23. The apparatus of claim 20, further comprising a foot support coupled to the front portion of each of the leg members.

24. The apparatus of claim 23, wherein the foot support is movable between a storage position and a use position.

25. The apparatus of claim 18, further comprising a seat coupled to the frame.

26. The apparatus of claim 25, wherein the seat has a seat length and the seat length is less than the leg member length.

27. The patient transport apparatus of claim 18, wherein the first and second leg members are adapted to movably support the frame, are shaped to fit substantially underneath a patient bed to engage a foot section of the bed when the foot section is moved from a position substantially parallel to a floor surface to a position substantially perpendicular to the floor surface.

28. The patient transport apparatus of claim 18, wherein the frame includes a top end, a bottom end spaced apart from the top end adjacent to a floor surface, a first side, and a second side spaced apart from the first side, and
the first and second leg members are coupled to the first and second sides of the frame, respectively, adjacent to the bottom end, the first and second leg members are adapted to movably support the frame, the first and second leg members include a rear portion extending substantially parallel to a longitudinal axis of the frame, a middle portion extending substantially perpendicular to the longitudinal axis of the frame, and a front portion extending substantially parallel to the frame, the rear portion is coupled to the frame, each of the rear portion, middle portion, and front portion have a length, and the length of the middle portion is greater than the length of the rear portion and the length of the front portion.

29. A patient transport apparatus comprising:
a frame adaptable for movably supporting a patient in a plurality of positions including a standing position and a seated position, and
first and second spaced apart arm members coupled to the frame, the first and second arm members being vertically movable relative to the frame from a first position to be operable as hand supports when the patient is in the standing position and a second position located below the first position to be operable as arm supports when the patient is in the seated position, the first and second arm members also being pivotably coupled to the frame between an outwardly-extending use position and a downwardly pivoted storage position.

30. The patient transport apparatus of claim 29, wherein each of the arm members is pivotable 360 degrees around a horizontal axis.

31. The patient transport apparatus of claim 29, further comprising a brake release mechanism coupled to at least one of the first and second arm members.

32. The patient transport apparatus of claim 31, further comprising a brake activating mechanism coupled to at least one of the first and second arm members.

33. The patient transport apparatus of claim 29, wherein the first and second arm members are pivotably coupled to the frame using a rotary locking mechanism.

34. The patient transport apparatus of claim 33, wherein the rotary locking mechanism includes a tightening knob.

35. The patient transport apparatus of claim 29, wherein the first and second arm members are vertically movably coupled to the frame using a lock mechanism.

36. The patient transport apparatus of claim 35, wherein the lock mechanism is one of a gas spring, a mech-lock, a hydraulic cylinder, a pneumatic cylinder, and a bolt screw.

37. The patient transport apparatus of claim 35, further comprising an arm adjustment mechanism coupled to the frame, the arm adjustment mechanism including an actuator to selectively release the lock mechanism and permit movement of the first and second arm members relative to the frame.

38. The patient transport apparatus of claim 29, wherein the frame has a top end and a bottom end spaced apart from the top end, further comprising a handle coupled to the frame adjacent the top end.

39. The patient transport apparatus of claim 38, further comprising an arm member position adjustment mechanism coupled to the handle.

40. The patient transport apparatus of claim 29, wherein the frame has a top end and a bottom end spaced apart from the top end, further comprising a support surface coupled to the top end.

41. The patient transport apparatus of claim 29, further comprising an arm member position adjustment mechanism coupled to the support surface.

42. The patient transport apparatus of claim 29, wherein
the frame has a top end, a bottom end, a middle portion located between the top end and the bottom end, first and second sides, and first and second longitudinal slots located in the first and second sides, respectively, and
the first and second arm members are coupled to the first and second sides of the frame, respectively, the first arm and second arm members are pivotable from a first position aligned parallel to the frame to a second position aligned substantially perpendicular to the frame and are slidable in the first and second longitudinal slots to adjust a height of the first and second arm members relative to the frame.

43. The patient transport apparatus of claim 29, further comprising:
a coupling mechanism coupling each of the first and second arm members to the frame, the coupling mechanism comprising
a pivot coupler adapted to permit rotation of each of the first and second arm members from a first position aligned substantially parallel to the frame to a second position aligned substantially perpendicular to the frame, and
a vertical adjustment coupler adapted to permit movement of each of the first and second arm members from a third position adjacent a top portion of the frame to a fourth position adjacent to a middle portion of the frame.
